(19) United States
(12) Patent Application Publication
(10) Pub. No.: US 2025/0316782 A1
(43) Pub. Date: Oct. 9, 2025

(54) EXPANSION TANK AND BATTERY COOLING SYSTEM

(71) Applicant: MAHLE International GmbH, Stuttgart (DE)

(72) Inventors: Ralf Zink, Stuttgart (DE); Markus Lang, Loechgau (DE)

(21) Appl. No.: 18/981,422

(22) Filed: Dec. 13, 2024

(30) Foreign Application Priority Data
Dec. 15, 2023 (DE) 10 2023 135 285.7
Oct. 29, 2024 (DE) 10 2024 131 481.8

(51) Int. Cl. H01M 10/52; H01M 10/613; H01M 50/317

(52) U.S. Cl. CPC H01M 10/52; H01M 10/613; H01M 50/317

(57) ABSTRACT

An expansion tank for a battery cooling system is disclosed. The expansion tank includes a tank housing made of plastic, a housing tray and at least one cover, which is placed on the housing tray from a first direction and is tightly connected to the housing tray, a drying device with a dryer housing made of plastic, a dryer insert arranged therein and a dryer housing cover closing the dryer housing. The tank housing and the dryer housing are formed in one piece and are connected to one another in a communicating manner. The dryer housing cover can be placed in a sealed manner onto the dryer housing from a second direction. The first direction is orthogonal to the second direction.

### CROSS-REFERENCE TO RELATED APPLICATIONS

This application claims priority to German Patent Application No. 10 2024 131 481.8 filed on Oct. 29, 2024, and German Patent Application No. 10 2023 135 285.7 filed Dec. 15, 2023, the contents of which are hereby incorporated by reference in their entirety.

### TECHNICAL FIELD

The present invention relates to an expansion tank with a dryer device and a battery cooling system with such an expansion tank.

### BACKGROUND

Electric or hybrid vehicles are increasingly becoming the focus of consumers due to environmental aspects and are therefore also becoming more widespread on the roads. In order to be able to increase both the range and the performance of such electric or hybrid vehicles, the aim is to keep a traction battery of such an electric or hybrid vehicle in an optimum temperature window for this traction battery, for which temperature control devices, in particular cooling devices, are used in a known manner.

Such a battery cooling system for cooling a traction battery in particular also includes an expansion tank in which air is stored as an expansion cushion for a temperature-related change in volume of the coolant. An increase in temperature causes the coolant to expand. If the resulting excess pressure is unable to escape, this can lead to high pressure in the expansion tank, which could potentially damage it and should therefore be avoided. For this reason, such expansion tanks usually have a connection to the environment in order to be able to reduce a temperature-related pressure difference by blowing air into the environment if necessary. In order to prevent or at least reduce the unwanted discharge of hydrocarbon compounds into the environment, adsorbers can be provided through which the air to be blown into the environment flows and which are arranged separately from the expansion tank. When the coolant cools down, it contracts, creating a vacuum in the expansion tank, which leads to fresh air being drawn in from the environment. In order to prevent or at least reduce the unwanted entry of moisture into the coolant, dryer cartridges were previously used, in which a desiccant was arranged through which the fresh air drawn in from the environment passed during the intake process, absorbing moisture and drying the fresh air drawn in.

However, the disadvantage of the known expansion tanks is that they are comparatively complex and therefore expensive to manufacture and maintain.

The present invention therefore deals with the problem of providing an improved or at least an alternative embodiment for an expansion tank, by means of which the disadvantages known from the prior art can be overcome.

According to the invention, this problem is solved by the object of the independent claim(s). Advantageous embodiments are the object of the dependent claims.

### SUMMARY

The present invention is based on the general idea of arranging for the first time a dryer unit of an expansion tank of a battery cooling system laterally on the tank housing, wherein at least one dryer housing is formed integrally with the tank housing, in particular with a housing tray of the tank housing, but can be opened laterally and can thus be produced inexpensively together with the tank housing, in particular with the housing tray of the tank housing, and at the same time can be fitted more easily with a dryer insert. Maintenance can be significantly simplified, particularly for an expansion tank installed in a motor vehicle, by means of the lateral access to the dryer unit. The expansion tank according to the invention for a battery cooling system has a plastic tank housing with a housing tray and at least one cover, which is placed on the housing tray from a first direction and is tightly connected to it. Further provided is the dryer unit with a dryer housing made of plastic, a dryer insert arranged therein and a dryer housing cover closing the dryer housing, wherein the tank housing, in particular the housing trough of the tank housing, and the dryer housing are formed in one piece and are connected to one another in a communicating manner and wherein the dryer housing cover can be placed tightly on the dryer housing from a second direction. In concrete terms, this means that the housing tray and the dryer housing are designed as a single, continuous component, wherein the cover fits onto the housing tray and the dryer housing cover fits onto the dryer housing. The first direction is orthogonal to the second direction. When there is excess pressure in the expansion tank, air escapes from the expansion tank into the environment through a first valve, while when there is a vacuum in the expansion tank, fresh air enters the expansion tank from the environment through a second valve. The term “fresh air” can/should be understood as ambient air. This not only makes it possible to manufacture the product in a cost-effective manner, since the tank housing, in particular the housing tray of the tank housing, and the dryer housing can be manufactured in a common plastic injection molding process, but it also allows for a comparatively simple loading of the desiccant into the dryer device, in particular during maintenance of an expansion tank installed in a motor vehicle. In addition, the desiccant can be pressed simultaneously with the welding of the dryer housing cover. This can reduce the pressurized surface and thus the stress on the weld. In other embodiments, the pressurized sealing or joining surface is also reduced.

In the case of a favorable further development of the expansion tank according to the invention, the drying device has a desiccant arranged in an air-permeable first bag or a dimensionally stable drying body made of a sintered, extruded, or injection-molded desiccant, or a drying cartridge designed as a drying insert with a desiccant arranged therein. A desiccant in an air-permeable first bag can be used to achieve a particularly easy adaptation to the shape of the packaging and thus the utilization of even the most inaccessible spaces. In particular, a dimensionally stable drying body makes handling easier. The outer contour of the dimensionally stable drying body can be adapted to an inner contour of the dryer housing, whereby an optimal utilization of space can be achieved and an unwanted bypass flow can be avoided. A dryer insert designed as a dryer cartridge offers the advantage of easier handling.

The first bag is designed to be made of a fabric, in particular a polyester or polyamide fabric. Polyester is lightweight and also does not absorb moisture, so the moisture absorption is caused solely by the desiccant. The design of the polyester fabric bag also offers the advantages of high strength, good workability and weldability, as well as high air permeability. The use of polyamide offers advantages such as high robustness and tear resistance, as well as high elasticity and durability.

Preferably, the desiccant is arranged as bulk material in the first bag. This allows the desiccant to optimally adapt to the inner contour of the dryer housing and be held in it in a form-fitting and fixed position. Manufacturing tolerances, which can lead to an undesirable bypass flow in rigid housings, can also be avoided with this type of design.

In another advantageous embodiment, the desiccant comprises silica gel or zeolite. Silica gel is a colorless silicon dioxide with a gel-like, rubbery to solid consistency. It has a large inner surface area (approx. 600 m²/g) and is highly water-absorbent. Zeolite can absorb approx. 20% of its own weight in moisture, generating heat in the process, which can also help with drying. The use of zeolite offers a strong dehumidification effect even at low moisture levels, while silica gel has a high water absorption rate and is also inexpensive.

In a particularly preferred embodiment, a spring is provided that biases the first bag. A spring of this kind can be used to achieve a reliable and fixed arrangement of the desiccant in the dryer housing, wherein the spring tension also prevents the desiccant from generating disturbing noises during operation, for example. Such a spring can, for example, be designed as an inexpensive coil spring. Pre-tensioning also prevents the grinding of desiccant arranged as loose bulk material in the first bag during operation. The pre-tensioning also ensures that the desiccant or bag is in contact with the dryer housing all the way around, so that the air to be dried is forced through the desiccant and cannot flow past it.

Another advantageous embodiment provides an adsorber with a plastic adsorber housing, an activated carbon insert arranged therein with activated carbon and an adsorber housing cover that closes the adsorber housing. The adsorber can be designed, for example, as an HC adsorber. The tank housing, in particular the housing tray of the tank housing, and the adsorber housing are designed in one piece and connected to one another in a communicating manner, whereby the tank housing, in particular the housing tray of the tank housing, can be produced together with the dryer housing and the adsorber housing in a common cost-effective plastic injection molding process. The adsorber housing cover can be placed tightly on the adsorber housing from the second direction, whereby maintenance of the adsorber and the dryer unit is possible from the same direction.

In a particularly preferred embodiment of the expansion tank according to the invention, the activated carbon of the adsorber is arranged in a second, air-permeable bag. Activated carbon arranged in a second air-permeable bag can in turn be used to achieve a particularly simple adaptation to the shape of the body and to utilize even the most inaccessible of spaces. In addition, an unwanted bypass flow can be avoided.

The second bag is also advantageously made of a fabric, in particular a polyester or polyamide fabric. In this way, the advantages described in particular with regard to the first bag made of polyester can also be achieved for the second bag.

Another advantageous design feature is the spring that tensions the second bag and thus the activated carbon. This type of spring can be used to achieve a reliable and fixed arrangement of the activated carbon in the adsorber housing, wherein the spring tension also prevents the activated carbon from being ground up during operation, for example, and thereby losing its effect.

At the very least, a cover should be welded, clipped, screwed or glued to the housing tray. In addition or as an alternative, the dryer housing cover can also be welded, clipped, screwed or glued to the dryer housing or the adsorber housing cover to the adsorber housing. A detachable connection between the dryer housing cover and the dryer housing and between the adsorber housing cover and the adsorber housing offers advantages if it becomes necessary to replace the desiccant or the activated carbon.

The dryer housing cover and the adsorber housing cover are advantageously designed as a single piece, in particular as a single-piece plastic injection molding. This not only reduces manufacturing costs, but also simplifies assembly and maintenance.

Preferably, at least one of the following components is made of polyoxymethylene (POM) or polyketone: Cover, housing tray, dryer housing cover, dryer housing, adsorber housing cover, adsorber housing. POM is a semi-crystalline thermoplastic with high mechanical strength and rigidity and, in addition, high wear resistance and low moisture absorption, which is particularly advantageous when used for the expansion tank according to the invention, since in this case water retention or moisture absorption increases the electrical conductivity of a dielectric coolant. Alternatively, polyketone can also be used as a plastic. Polyketones (PK) are high-performance thermoplastic polymers with high impact strength, low wear, good solvent resistance, and low water absorption. Polyketone also has a high level of environmental compatibility. In order to further increase the mechanical strength and also the wear resistance, the plastic can have glass fibers, in particular 25% glass fibers, and in particular be designed as POM GF-25.

The present invention is further based on the general idea of equipping a battery cooling system with an expansion tank described in the previous paragraphs and thereby transferring the advantages described with respect to the expansion tank to the battery cooling system. Specifically, the advantages of a battery cooling system equipped with the expansion tank according to the invention are low-cost production and easy maintenance.

Further important features and advantages of the invention are apparent from the sub-claims, from the drawings, and from the associated description of the figures with reference to the drawings.

It is understood that the features mentioned above and those to be explained below can be used not only in the combination indicated in each case, but also in other combinations or on their own, without departing from the scope of the present invention. The above-mentioned components of a superordinate unit, such as a device, an apparatus, or an arrangement, which are designated separately, can form separate parts or components of this unit or be integral areas or sections of this unit, even if this is shown differently in the drawing.

Preferred exemplary embodiments of the invention are shown in the drawings and are explained in more detail in the following description, wherein identical reference signs refer to identical or similar or functionally identical components.

### BRIEF DESCRIPTION OF THE DRAWINGS

It shows, schematically in each case

FIG. 1 illustrates a view of an expansion tank of a battery cooling system according to the invention,

FIG. 2 illustrates a representation as in FIG. 1, but from a different perspective,

FIG. 3 illustrates a sectional view through an expansion tank according to the invention in the area of a dryer device,

FIG. 4 illustrates a detailed view from FIG. 3,

FIG. 5 illustrates a sectional view through an expansion tank according to the invention in the area of an adsorber,

FIG. 6 illustrates a detailed view of FIG. 5.

### BRIEF DESCRIPTION

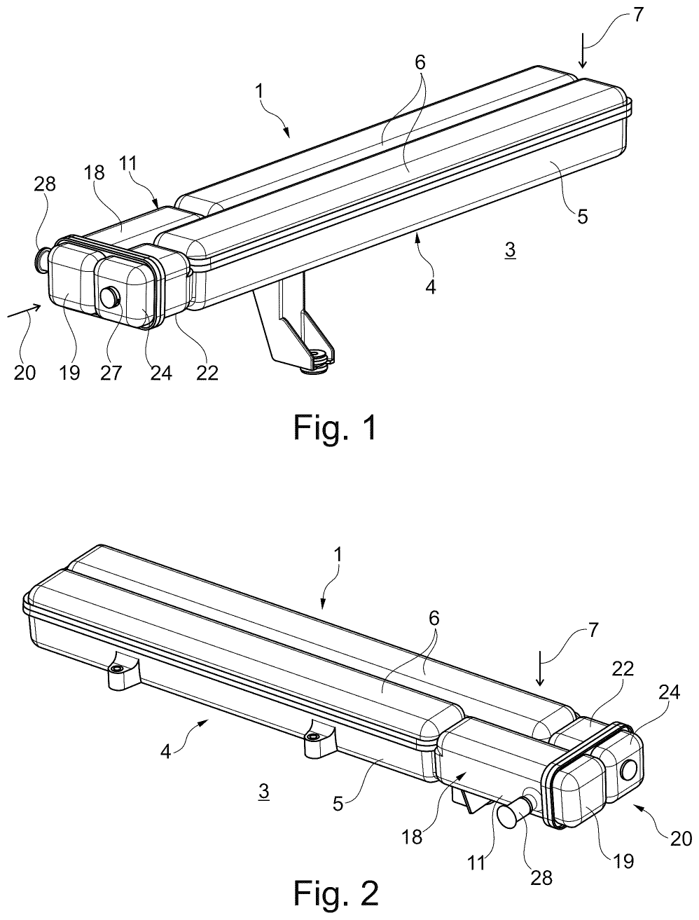

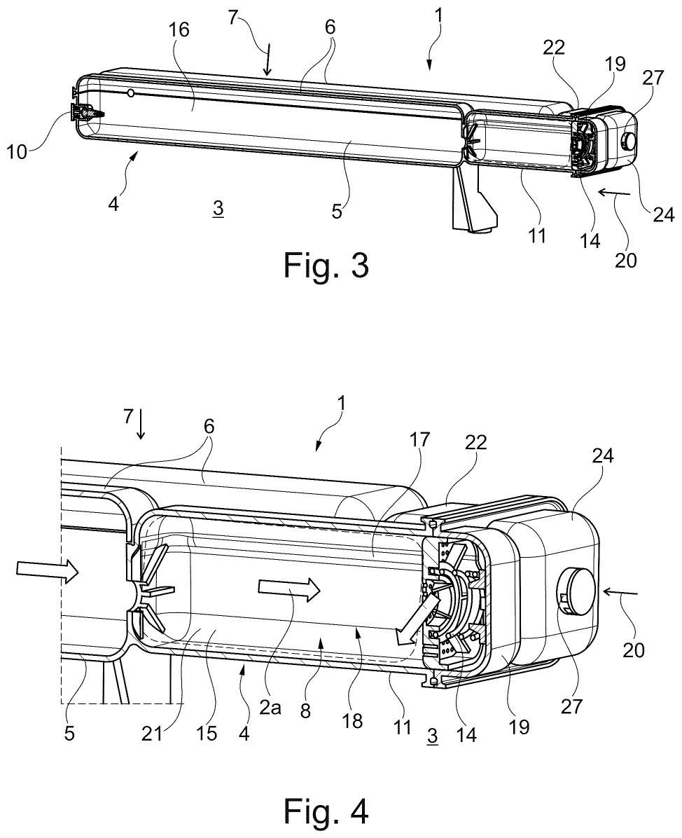

According to FIGS. 1 through 6, an expansion tank 1 for air 2 of an inventive battery cooling system 3 has a plastic tank housing 4 with a housing tray 5 and two covers 6, which are placed on the housing tray 5 from a first direction 7 and are tightly connected to it. The two covers 6 can also be designed as a single piece, thereby forming a common cover 6 for covering the housing tray 5. In addition, the expansion tank 1 has a dryer device 8 with a dryer housing 11 made of plastic, a dryer insert 18 arranged therein and a dryer housing cover 19 closing the dryer housing 11, wherein the tank housing 4, in particular the housing tray 5 of the tank housing 4, and the dryer housing 11 are formed in one piece and are connected to one another in a communicating manner. The dryer housing cover 19 can be placed tightly on the dryer housing 11 from a second direction 20, wherein the first direction 7 is orthogonal to the second direction 20. This not only makes it possible to manufacture the tank in a cost-effective manner, since the tank housing 4, in particular the housing tray 5 of the tank housing 4, and the dryer housing 11 can be manufactured, for example, in a common plastic injection molding operation, but it is also possible to fit the drying device 8 with the drying insert 18 and the desiccant 21 contained therein in a comparatively simple manner, in particular during maintenance of an expansion tank 1 installed in a motor vehicle.

The dryer device 8 preferably has a desiccant 21 arranged in an air-permeable first bag 15, wherein the dryer device 8 may alternatively also have a dimensionally stable drying body 17 made of a sintered, extruded or injection-molded desiccant 21. Both versions are shown in FIG. 4, although it is of course clear that they are only used as alternatives.

If one looks at FIG. 4, one can see a drying device 8 in which the first bag 15 is formed from a fabric, in particular from a polyester fabric or a polyamide fabric. Of course, other materials that are resistant to the coolant in the battery cooling system 3 are also conceivable. The desiccant 21 can be arranged as bulk material in the first bag 15, for example as a bead-shaped silica gel or zeolite. This allows the outer contour of the dryer insert 18 to be optimally adapted to the inner contour of the dryer housing 11, thus enabling a form-fitting and reliable fit. In particular, the form-fit mounting can also prevent an undesired bypass flow of the fresh air 2a drawn in.

The desiccant 21 used for the dimensionally stable drying body 17 can also contain silica gel or zeolite. According to FIG. 4, the dimensionally stable drying body 17 made of pressed, sintered, extruded or injection-molded desiccant 21 can have an outer contour that is complementary to the inner contour of the dryer housing 11 and thus also avoids an undesired bypass flow of the drawn-in fresh air 2a. The dimensionally stable drying body 17 makes it possible to dispense with an additional casing, such as the first bag 15, which reduces manufacturing costs.

The expansion tank 1 according to the invention can further comprise an adsorber 12 with an adsorber housing 22 made of plastic, an activated carbon insert 23 arranged therein with activated carbon 25 and an adsorber housing cover 24 closing the adsorber housing 22.

An opening 27 may be provided in the adsorber housing cover 24, through which air 2 can be blown out into the environment when there is a corresponding overpressure.

The tank housing 4, in particular the housing tray 5 of the tank housing 4, and the adsorber housing 22 are designed in one piece and connected to one another in a communicating manner, whereby the tank housing 4 can be produced together with the dryer housing 11 and the adsorber housing 22 in a common cost-effective plastic injection molding process. The adsorber housing cover 24 can also be placed tightly on the adsorber housing 22 from the second direction 20, whereby maintenance of the adsorber 12 and the dryer device 8 is possible from the same direction, here the second direction 20.

The dryer housing cover 19 and the adsorber housing cover 24 can be designed as a single piece, in particular as a single-piece plastic injection molding, which reduces manufacturing costs and simplifies handling. Alternatively, the dryer housing cover 19 and the adsorber housing cover 24 can also be designed separately from one another.

The activated carbon 25 of the activated carbon insert 23 or the adsorber 12 can be arranged in an air-permeable second bag 26.

In the event of excess pressure in the expansion tank 1, air 2 can escape from the expansion tank 1 into the environment through a first valve 9, wherein the air 2 can flow through an adsorber 12 for cleaning. By blowing air 2 through the adsorber 12, pollutants such as hydrocarbons in particular can be reliably retained. A second valve 10 can be used to draw fresh air 2a from the environment into the expansion tank 1 when there is a vacuum in the expansion tank 1. The battery cooling system 3 is connected to the expansion tank 1 by means of a connection 28, for example a quick connector. Fresh air 2a from the environment is drawn into the expansion tank 1 via the second valve 10 and the drying device 8, in which the fresh air 2a drawn in is dried.

The first valve 9 is arranged in the intermediate wall 13 that separates the adsorber 12 from the interior 16 of the tank housing 4. The second valve 10 is arranged in an outer wall of the tank housing 4. Of course, the second valve 10 described above and a further pressure relief valve, via which air 2 is blown out of the expansion tank 1 into the environment, can also be arranged in the outer wall of the tank housing 4.

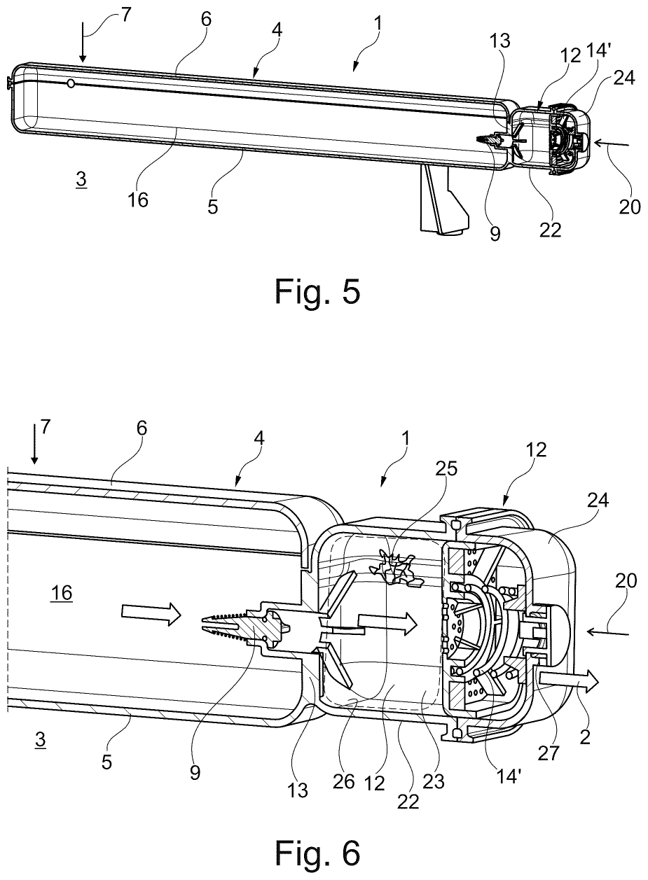

If you look at FIGS. 5 and 6 further, you can see that a spring 14′ is arranged on the adsorber 12, which prestresses the adsorber 12 or the activated carbon 25 against the tank housing 4, in this case specifically against a partition 13. The spring 14′ can be used to fix the adsorber 12 in a vibration-free and thus rattle-free manner. This can be used in particular to achieve increased user comfort due to lower noise levels and also to prevent the activated carbon 25 from being ground up in the activated carbon insert 23.

The tank housing 4, that is to say the tank tray 5 and/or the cover 6, but also the dryer housing 11, the dryer housing cover 19, the adsorber housing 22 and the adsorber housing cover 24 can be designed as plastic injection molding parts, whereby not only a high-quality but also a cost-effective production is made possible.

At least one cover 6 can be welded, clipped, screwed or glued to the housing tray 5. Additionally or alternatively, the dryer housing cover 19 can be welded, clipped, screwed, or glued to the dryer housing 11 and/or the adsorber housing cover 24 can be welded, clipped, screwed, or glued to the adsorber housing 22. In particular, a clip connection or screw connection offers the great advantage that the dryer housing 11 or the adsorber housing 22 can be opened to replace the dryer insert 18 or the activated carbon insert 23 and can continue to be used after the dryer insert 18 or the activated carbon insert 23 has been replaced.

At least one of the following components can also be made of polyoxymethylene (POM) or polyketone, i.e., a plastic with high strength and low moisture absorption, which is particularly advantageous for an expansion tank 1 for air 2 of a battery cooling system 3: cover 6, housing tray 5, dryer housing cover 19, dryer housing 11, adsorber housing cover 24, adsorber housing 22. In order to further increase the strength and wear resistance of the tank housing 4, the plastic can also have glass fibers, in particular a 25% glass fiber content in the plastic.

All in all, an extremely cost-effective and space-optimized solution can be created with the expansion tank 1 and the battery cooling system 3 according to the invention.

1. An expansion tank for a battery cooling system, comprising:
a tank housing composed of plastic, with a housing tray and at least one cover that is placed on the housing tray from a first direction and is tightly connected to the housing tray,
a drying device with a dryer housing composed of plastic, a dryer insert arranged therein and a dryer housing cover closing the dryer housing,
wherein the tank housing and the dryer housing are formed in one piece and are connected to one another in a communicating manner,
wherein the dryer housing cover is sealably mountable on the dryer housing from a second direction,
wherein the first direction is orthogonal to the second direction,
a first valve, through which air can escape from the expansion tank into an environment when there is excess pressure in the expansion tank, and
a second valve, via which fresh air from the environment enters the expansion tank when there is a vacuum in the expansion tank.

2. The expansion tank according to claim 1, wherein:
the drying device has a desiccant arranged in an air-permeable first bag, or
the drying device has a dimensionally stable drying body composed of a sintered, extruded or injection-molded desiccant, or
the dryer insert is structured as a dryer cartridge with a desiccant arranged therein.

3. The expansion tank according to claim 2, wherein the first bag is formed from a woven fabric.

4. The expansion tank according to claim 2, wherein the desiccant is arranged as bulk material in the first bag.

5. The expansion tank according to claim 2, wherein the desiccant comprises silica gel or zeolite.

6. The expansion tank according to claim 2, further comprising a spring that biases the desiccant in the first bag or drying cartridge.

7. The expansion tank according to claim 1, wherein:
an adsorber is provided with an adsorber housing composed of plastic, an activated carbon insert arranged therein with activated carbon and an adsorber housing cover closing the adsorber housing,
the tank housing and the adsorber housing are structured in one piece and connected to one another in a communicating manner, and
the adsorber housing cover can be tightly placed on the adsorber housing from the second direction.

8. The expansion tank according to claim 7, wherein the activated carbon of the adsorber is arranged in an air-permeable second bag.

9. The expansion tank according to claim 8, further comprising a spring that biases the second bag and, above it, the activated carbon arranged therein.

10. The expansion tank according to claim 6, wherein:
the at least one cover is welded, clipped, screwed, or glued to the housing tray, and/or
the dryer housing cover is welded, clipped, screwed, or glued to the dryer housing, and/or
an adsorber housing cover of an adsorber is welded, clipped, screwed, or glued to an adsorber housing of the adsorber.

11. The expansion tank according to claim 6, wherein the dryer housing cover and an adsorber housing cover of an adsorber are structured in one piece.

12. The expansion tank according to claim 1, wherein at least one of the following components is composed of polyoxymethylene (POM) or polyketone: the cover, the housing tray, the dryer housing cover, the dryer housing, an adsorber housing cover of an adsorber, and an adsorber housing of the adsorber.

13. The expansion tank according to claim 6, wherein the plastic has glass fibers.

14. A battery cooling system, comprising: an expansion tank, the expansion tank including:
a tank housing composed of plastic, with a housing tray and at least one cover that is placed on the housing tray from a first direction and is tightly connected to the housing tray,
a drying device with a dryer housing composed of plastic, a dryer insert arranged therein and a dryer housing cover closing the dryer housing,
wherein the tank housing and the dryer housing are formed in one piece and are connected to one another in a communicating manner,
wherein the dryer housing cover is sealably mountable on the dryer housing from a second direction,
wherein the first direction is orthogonal to the second direction,
a first valve, through which air can escape from the expansion tank into an environment when there is excess pressure in the expansion tank, and
a second valve, via which fresh air from the environment enters the expansion tank when there is a vacuum in the expansion tank.

15. The battery cooling system according to claim 14, wherein the drying device has a desiccant arranged in an air-permeable first bag.

16. The battery cooling system according to claim 15, wherein the first bag is formed from a woven fabric.

17. The battery cooling system according to claim 15, wherein the desiccant is arranged as bulk material in the first bag.

18. The battery cooling system according to claim 14, wherein the drying device has a dimensionally stable drying body composed of a sintered, extruded or injection-molded desiccant.

19. The battery cooling system according to claim 14, wherein the dryer insert is structured as a dryer cartridge with a desiccant arranged therein.

20. The battery cooling system according to claim 14, wherein:
an adsorber is provided with an adsorber housing composed of plastic, an activated carbon insert arranged therein with activated carbon and an adsorber housing cover closing the adsorber housing,
the tank housing and the adsorber housing are structured in one piece and connected to one another in a communicating manner, and
the adsorber housing cover can be tightly placed on the adsorber housing from the second direction.
